(19) United States
(12) Patent Application Publication
(10) Pub. No.: US 2026/0095102 A1
(43) Pub. Date: Apr. 2, 2026

(54) SWITCHING CONVERTER WITH WIDE INPUT VOLTAGE RANGE AND CONTROL CIRCUIT THEREOF

(71) Applicant: Hangzhou MPS Semiconductor Technology, Ltd., Hangzhou (CN)

(72) Inventor: Lei Du, Hangzhou (TW)

(21) Appl. No.: 19/343,955

(22) Filed: Sep. 29, 2025

(30) Foreign Application Priority Data
Sep. 30, 2024 (CN) 202411383434.4

(51) Int. Cl. H02M 3/158; H02M 1/00

(52) U.S. Cl. CPC H02M 3/1582; H02M 1/0009

(57) ABSTRACT

A switching converter includes a first and second switch pair, an inductor, a first and second error amplifying circuit, a control voltage generator, and a pulse width modulation circuit. The first error amplifying circuit provides a first error amplifying signal based upon an output feedback signal representative of an output voltage and an output reference signal. The second error amplifying circuit provides a second error amplifying signal based upon the first error amplifying signal and a current sense signal representative of a current flowing through the inductor. The control voltage generator provides a control voltage based upon a voltage difference between the second error amplifying signal and a reference voltage. The pulse width modulation circuit provides a first pulse width modulation signal to control the first switch pair and a second pulse width modulation signal to control the second switch pair, based upon an input voltage, the output voltage and the control voltage.

### CROSS-REFERENCE TO RELATED APPLICATIONS

This application claims the benefit of CN application 202411383434.4, filed on Sep 30, 2024, and incorporated herein by reference.

### TECHNICAL FIELD

The present invention generally relates to electronic circuits, and more particularly but not exclusively, to switching converters with wide input voltage range and associated control circuits.

### BACKGROUND

Buck-boost switching converters can convert an input voltage into an output voltage higher than, equal to or lower than the input voltage and can generally be operated with wide input voltage range. With the development of electronic technology, a buck-boost switching converter is widely used in power management applications. From handheld electronic devices such as, a tablet personal computer, an e-book, a digital camera, to large electronic devices such as, a server, a computing base station and so on, all require the buck-boost converter, to meet a demand of wide input voltage range.

### SUMMARY

There has been provided, in accordance with an embodiment of the present disclosure, a switching converter. The switching converter includes a first switch pair, a second switch pair, a first error amplifying circuit, a second error amplifying circuit, a control voltage generator and a pulse width modulation circuit. The first switch pair is coupled in series between an input voltage and a reference ground. A first terminal of an inductor is selectively coupled to the input voltage or the reference ground based upon a first pulse width modulation signal. The second switch pair is coupled in series between an output voltage and the reference ground. A second terminal of the inductor is selectively coupled to the output voltage or the reference ground based upon a second pulse width modulation signal. The first error amplifying circuit is configured to receive an output feedback signal representative of the output voltage and to provide a first error amplifying signal based upon the output feedback signal and an output reference signal. The second error amplifying circuit is configured to receive the first error amplifying signal and a current sense signal representative of a current flowing through the inductor, and to provide a second error amplifying signal based upon the first error amplifying signal and the current sense signal. The control voltage generator has a first input terminal to receive the second error amplifying signal and a second input terminal to receive a reference voltage, and is configured to provide a control voltage based upon a voltage difference between the second error amplifying signal and the reference voltage. The pulse width modulation circuit is configured to provide the first pulse width modulation signal for controlling the first switch pair and the second pulse width modulation signal for controlling the second switch pair, based upon the input voltage, the output voltage and the control voltage.

There has also been provided, in accordance with an embodiment of the present disclosure, a control circuit for a switching converter. The control circuit comprises a first error amplifying circuit, a second error amplifying circuit, a control voltage generator and a pulse width modulation circuit. The first error amplifying circuit is configured to receive an output feedback signal representative of an output voltage of the switching converter and to provide a first error amplifying signal based upon the output feedback signal and an output reference signal. The second error amplifying circuit is configured to receive the first error amplifying signal and a current sense signal representative of a current flowing through an inductor of the switching converter, and to provide a second error amplifying signal based upon the first error amplifying signal and the current sense signal. The control voltage generator has a first input terminal to receive the second error amplifying signal and a second input terminal to receive a reference voltage, and is configured to provide a control voltage based upon a voltage difference between the second error amplifying signal and the reference voltage. The pulse width modulation circuit is configured to provide a first pulse width modulation signal and a second pulse width modulation signal based upon an input voltage, the output voltage and the control voltage. The first pulse width modulation signal is used to control a first switch pair of the switching converter for selectively coupling a first terminal of the inductor to the input voltage or a reference ground of the switching converter. The second pulse width modulation signal is used to control a second switch pair of the switching converter for selectively coupling a second terminal of the inductor to the output voltage or the reference ground.

There has also been provided, in accordance with an embodiment of the present disclosure, a control circuit for a switching converter. The control circuit switches between a first mode and a second mode when an input voltage approaches an output voltage. In the first mode, during one switching cycle, a first terminal of an inductor of the switching converter is selectively coupled to the input voltage or a reference ground and a voltage at a second terminal of the inductor is substantially equal to the output voltage. In the second mode, during one switching cycle, a voltage at the first terminal of the inductor is substantially equal to the input voltage and the second terminal of the inductor is selectively coupled to the output voltage or the reference ground.

### BRIEF DESCRIPTION OF DRAWINGS

The present invention can be further understood with reference to the following detailed description and the appended drawings, wherein like elements are provided with like reference numerals.

FIG. 1 shows a block diagram of an electronic device 100 in accordance with an embodiment of the present invention.

FIG. 2 shows a schematic diagram of a switching converter 10A in accordance with an embodiment of the present invention.

FIG. 3 shows partial circuit diagram of the control circuit 104B in accordance with an embodiment of the present invention.

FIG. 4 shows a pulse width modulation circuit 44A in accordance with an embodiment of the present invention.

FIG. 5a~5d respectively show working waveforms of the pulse width modulation circuit 44A in accordance with a respective embodiment of the present invention.

FIG. 6 shows working waveform of the switching converter 10A shown in FIG. 2 in accordance with an embodiment of the present invention.

FIG. 7 shows a zoom-in view of the working waveforms during a period from A to B shown in FIG. 6 in accordance with an embodiment of the present invention.

FIG. 8 shows partial circuit diagram of the control circuit 104C in accordance with an embodiment of the present invention.

FIG. 9 shows a flow diagram of a method 600 used in a switching converter in accordance with an embodiment of the present invention.

FIG. 10 shows a flow diagram of a step 604 shown in FIG. 9 in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to "one embodiment", "an embodiment", "an example" or "examples" means: certain features, structures, or characteristics are contained in at least one embodiment of the present invention. These "one embodiment", "an embodiment", "an example" and "examples" are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as "connected" or "coupled" to another element, it can be directly connected or coupled to the other element, or there could exist one or more intermediate elements. In contrast, when an element is referred to as "directly connected" or “directly coupled” to another element, there is no intermediate element.

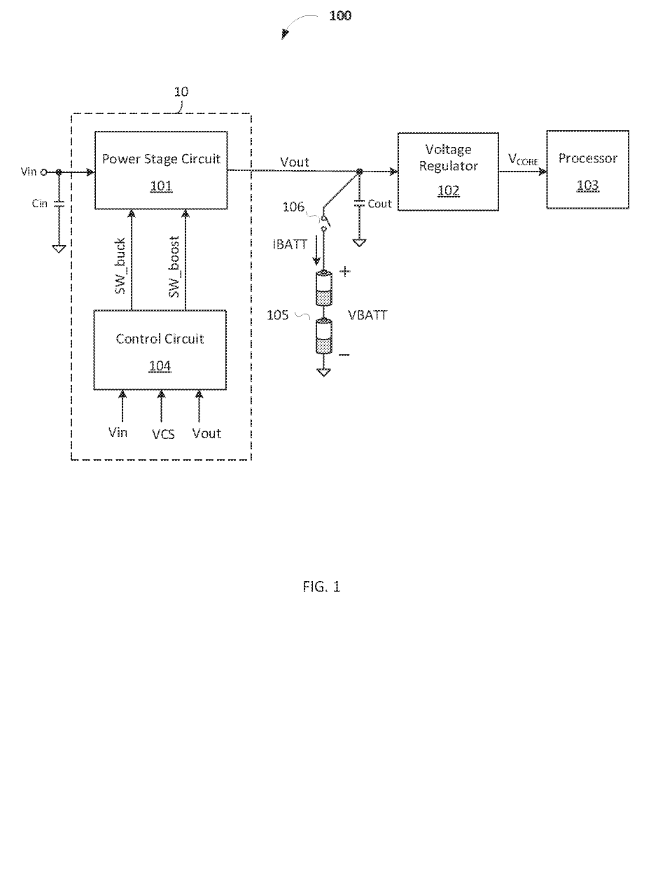

FIG. 1 shows a schematic diagram of an electronic device 100 in accordance with an embodiment of the present invention. The electronic device 100 comprises a switching converter 10, a voltage regulator (VR) 102, and a processor 103. The switching converter 10 comprises a power stage 101 and a control circuit 104. The processor 103 may be a central processing unit (CPU), a graphics processing unit (GPU) or an application specific integrated circuit (ASIC). In one embodiment, the electronic device 100 is part of a computing platform. The switching converter 10, a battery 105 and the voltage regulator 102 are configured to provide power to the computing platform. In detail, the switching converter 10 and/or the battery 105 may provide an output voltage Vout for the computing platform, the voltage regulator 102 converts the output voltage Vout to a processor voltage V_{CORE} to the processor 103.

As shown in FIG. 1, the power stage circuit 101 has an input terminal to receive an input voltage Vin and an output terminal to provide the output voltage Vout. Based on the input voltage Vin, the output voltage Vout and a current sense signal VCS representative of a current flowing through an energy storge device (e.g., inductor) of the power stage circuit 101, the control circuit 104 provides a first pulse width modulation signal SW_buck and a second pulse width modulation signal SW_boost, to control power switches of the power stage circuit 101. In one embodiment, the power stage circuit 101 and a switch 106 could be configured as a narrow voltage direct current (NVDC) battery charging circuit. When the power stage circuit 101 is connected to an external power supply, for example, an external AC power supply adapter or an external USB port, the external power supply provides the output voltage Vout via the power stage circuit 101, and provides a charging current IBATT to charge the battery 105 via the switch 106.

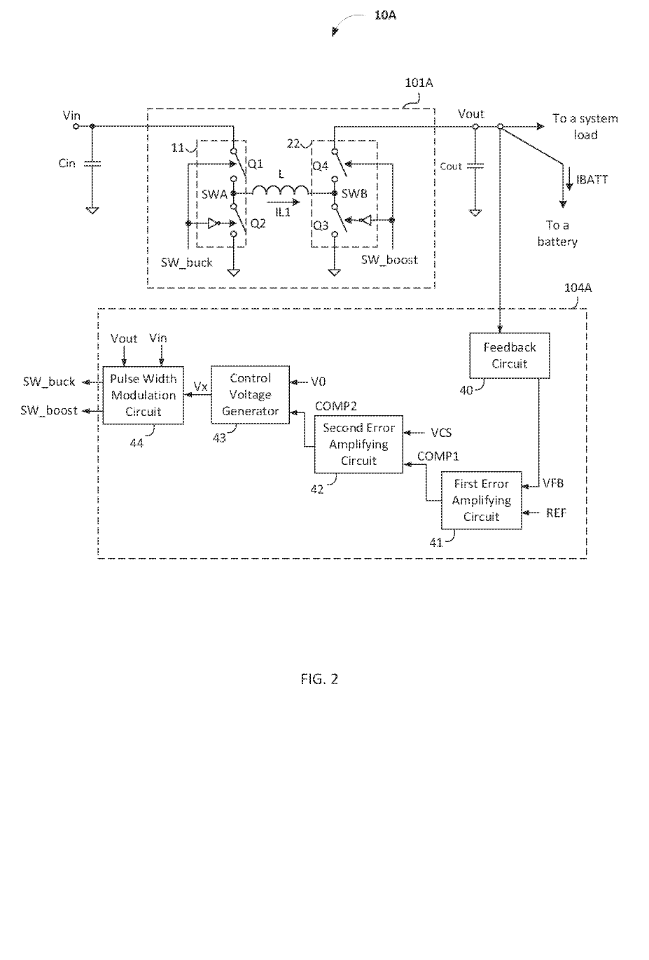

FIG. 2 shows a switching converter 10A in accordance with an embodiment of the present invention. As shown in FIG. 2, the power stage circuit 101A is a buck-boost converter. The power stage circuit 101A comprises switches Q1~Q4 and an inductor L. An input capacitor Cin is coupled between an input terminal and a reference ground, an output capacitor Cout is coupled between an output terminal and the reference ground. In one embodiment, the power stage circuit 101A is configured to provide the output voltage Vout to a system load (e.g., a voltage regulator 102 and/or processor 103 as shown in FIG. 1), as well as to provide the charging current IBATT to charge a battery.

As shown in FIG. 2, a first switch pair 11 comprises a first switch Q1 and a second switch Q2 coupled in series between an input voltage Vin and the reference ground. The first switch Q1 and the second switch Q2 may work complementarily under the control of the first pulse width modulation signal SW_buck, and a first terminal SWA of the inductor L is selectively coupled to one of the input voltage Vin and the reference ground. A second switch pair 22 comprises a fourth switch Q4 and a third switch Q3 coupled in series between the output voltage Vout and the reference ground. The third switch Q3 and the fourth switch Q4 may work complementarily under the control of the second pulse width modulation signal SW_boost, and a second terminal SWB of the inductor L is selectively coupled to one of the output voltage Vout and the reference ground. The switches Q1~Q4 may be any controllable semiconductor devices, such as MOSFET (metal oxide semiconductor field effect transistor), IGBT (isolated gate bipolar transistor), SiC (Silicon Carbide), GaN (Gallium Nitride) and so on.

In the embodiment shown in FIG. 2, the control circuit 104A comprises a feedback circuit 40, a first error amplifying circuit 41, a second error amplifying circuit 42, a control voltage generator 43, and a pulse width modulation circuit 44. As shown in FIG. 2, the feedback circuit 40 has an input terminal coupled to the output terminal of the power stage circuit 101A to receive the output voltage Vout, and has an output terminal to provide an output feedback signal VFB representative of the output voltage Vout. In one embodiment, the feedback circuit 40 may simply comprise a buffer or a conductor or the like, so that the output feedback signal VFB has substantially the same voltage level as the output voltage Vout. In another embodiment, the feedback circuit 40 may include a voltage divider or the like in which the output feedback signal VFB is proportional to the output voltage Vout.

Referring still to FIG. 2, the first error amplifying circuit 41 has a first input terminal, a second input terminal and an output terminal. The first input terminal of the first error amplifying circuit 41 receives the output feedback signal VFB, the second input terminal of the first error amplifying circuit 41 receives an output reference signal REF. The first error amplifying circuit 41 amplifies a difference between the output feedback signal VFB and the output reference signal REF and provides a first error amplifying signal COMP1 at the output terminal. The output reference signal REF may indicate a target voltage level of the output voltage Vout. In one embodiment, the first error amplifying circuit 41 may provide some loop compensation at the output terminal to keep the output feedback signal VFB at a level equal to the output reference signal REF.

The first error amplifying signal COMP1 is provided to a first input terminal of the second error amplifying circuit 42. A second input terminal of the second error amplifying circuit 42 receives a current sense signal VCS. The current sense signal VCS is representative of a current IL1 flowing through the inductor L. The second error amplifying circuit 42 amplifies a difference between the first error amplifying signal COMP1 and the current sense signal VCS and provides a second error amplifying signal COMP2 at an output terminal. In one embodiment, the second error amplifying circuit 42 may provide some loop compensation at the output terminal to finally keep the current sense signal VCS at a level equal to the first error amplifying signal COMP1.

In one embodiment, the switching converter 10A further comprise a current sense circuit (not shown), to provide the current sense signal VCS. The current sense circuit may comprise a sensing resistor coupled in series with the inductor L, a voltage across the sensing resistor is detected using a sensing amplifier to produce the current sense signal VCS proportional to the current IL1. Alternatively, internal resistance (RDSON) between drain and source of the power switches (Q1~Q4) can be used to detect the current IL1. Since a current flowing though one of the power switches (Q1~Q4) is simply a part of the current IL1, multiple current sensing circuits may be required to respectively detect the current flowing through each power switch, and then to provide the current sense signal VCS based thereupon.

In the embodiment shown in FIG. 2, the control voltage generator 43 has a first input terminal, a second input terminal and an output terminal. The first input terminal of the control voltage generator 43 receives the second error amplifying signal COMP2, the second input terminal of the control voltage generator 43 receives a reference voltage V0. Based on a voltage difference between the second error amplifying signal COMP2 and the reference voltage V0, the control voltage generator 43 provides a control voltage Vx at the output terminal. In one embodiment, the reference voltage V0 is a constant voltage level, such as 1V.

The pulse width modulation circuit 44 is configured to provide the first pulse width modulation signal SW_buck and the second pulse width modulation signal SW_boost based upon the input voltage Vin, the output voltage Vout and the control voltage Vx. The first pulse width modulation signal SW_buck is used to control the first switch pair 11, for selectively coupling the first terminal SWA of the inductor L to the input voltage Vin or the reference ground. The second pulse width modulation signal SW_boost is used to control the second switch pair 22, for selectively coupling the second terminal SWB of the inductor L to the output voltage Vout or the reference ground.

In one embodiment, the control circuit 104B further comprises a first driver and a second driver. The first driver comprises a non-inverting driving circuit and an inverting driving circuit to control the switches Q1 and Q2, respectively, and these driving circuits are both controlled or activated by the first pulse width modulation signal SW_buck. The second driver comprises a non-inverting driving circuit and an inverting driving circuit to control the switches Q4 and Q3, respectively, and these driving circuits are both controlled or activated by the second pulse width modulation signal SW_boost. The switches Q1 and Q2 can work complementarily, while the switches Q4 and Q3 can work complementarily.

In one embodiment, when the second pulse width modulation signal SW_boost is kept at a constant voltage level (e.g., a logic high), during a switching cycle, the third switch Q3 is maintained off and the fourth switch Q4 is maintained on. The first switch Q1 is turned on and the second switch Q2 is turned off in response to the first pulse width modulation signal SW_buck being logic high, the first switch Q1 is turned off and the second switch Q2 is turned on in response to the first pulse width modulation signal SW_buck being logic low.

In one embodiment, when the first pulse width modulation signal SW_buck is kept at a constant voltage level (e.g., logic high), during a switching cycle, the first switch Q1 is maintained on and the second switch Q2 is maintained off. The fourth switch Q4 is turned on and the third switch Q3 is turned off in response to the second pulse width modulation signal SW_boost being logic high, the fourth switch Q4 is turned off and the third switch Q3 is turned on in response to the second pulse width modulation signal SW_boost being logic low.

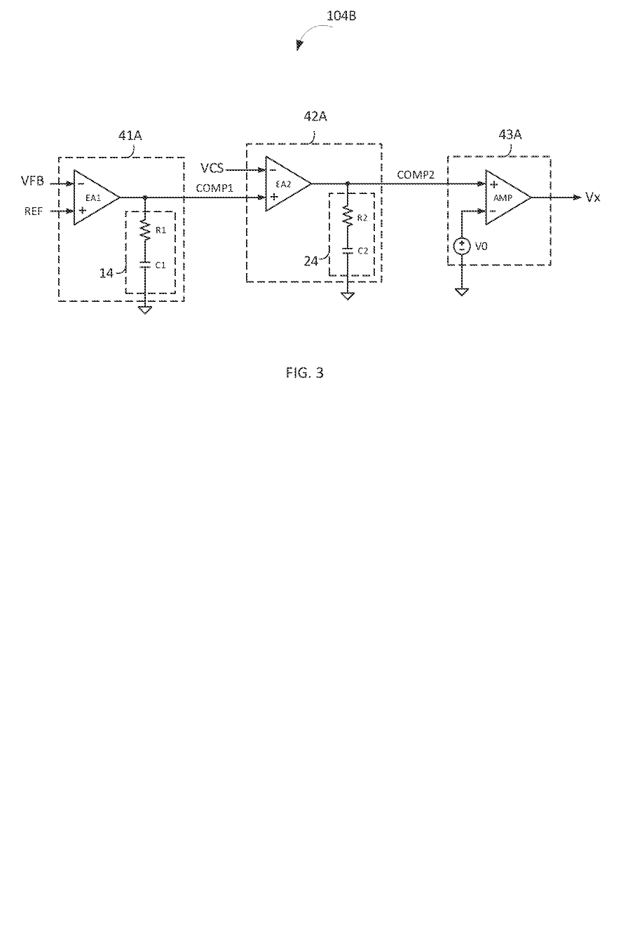

FIG. 3 shows partial circuit diagram of the control circuit 104B in accordance with an embodiment of the present invention. As shown in FIG. 3, the first error amplifying circuit 41A comprises an error amplifier EA1 and a compensation circuit 14. A non-inverting input terminal of the error amplifier EA1 receives the output reference signal REF. An inverting input terminal of the error amplifier EA1 receives the output feedback signal VFB. The compensation circuit 14 is coupled to an output terminal of the error amplifier EA1 to provide the loop compensation. In one example, the compensation circuit 14 comprises a compensation resistor R1 and a compensation capacitor C1, and performs a PI compensation to proportionally integrate an output signal of the error amplifier EA1 to provide the first error amplifying signal COMP1. In another embodiment, the compensation circuit 14 may perform other type of compensation.

In the embodiment shown in FIG. 3, the second error amplifying circuit 42A comprises an error amplifier EA2 and a compensation circuit 24. A non-inverting input terminal of the error amplifier EA2 is coupled to the output terminal of the first error amplifying circuit 41A to receive the first error amplifying signal COMP1. An inverting input terminal of the error amplifier EA2 receives the current sense signal VCS. The compensation circuit 24 is coupled to an output terminal of the error amplifier EA2 to provide the loop compensation. In one example, the compensation circuit 24 comprises a compensation resistor R2 and a compensation capacitor C2, and performs a PI compensation to proportionally integrate an output signal of the error amplifier EA2 to provide the second error amplifying signal COMP2. In another embodiment, the compensation circuit 24 may perform other type of compensation.

The control voltage generator 43A has a first input terminal to receive the second error amplifying signal COMP2 and a second input terminal to receive the reference voltage V0, and is configured to provide the control voltage Vx based upon a voltage difference between the second error amplifying signal COMP2 and the reference voltage V0. In one embodiment, the control voltage generator 43A comprises a voltage-controlled voltage source configured to generate the control voltage Vx proportional to the voltage difference.

In another embodiment, the control voltage generator 43A comprises an operational amplifier AMP. A non-inverting input terminal of the operational amplifier AMP receives the second error amplifying signal COMP2. An inverting input terminal of the operational amplifier AMP is coupled to a positive terminal of a reference voltage source to receive the reference voltage V0. A negative terminal of the reference voltage source is coupled to the reference ground. The operational amplifier AMP provides the control voltage Vx based upon the voltage difference between the second error amplifying signal COMP2 and the reference voltage V0.

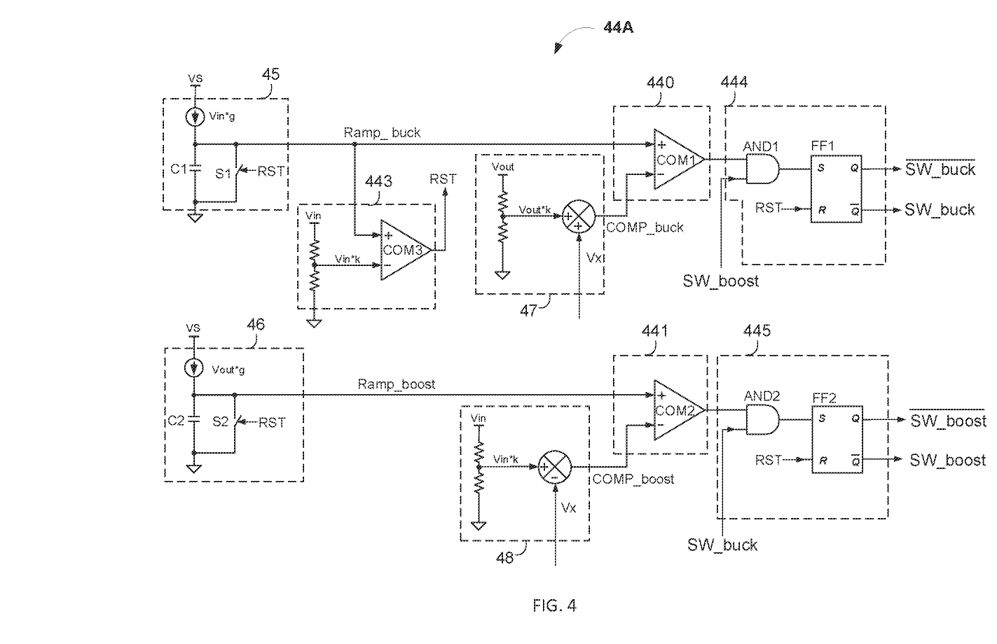

FIG. 4 shows a pulse width modulation circuit 44A in accordance with an embodiment of the present invention. As shown in FIG. 4, the pulse width modulation circuit 44A comprises a first comparison circuit 440, a second comparison circuit 441, a switching cycle control circuit 443, a first logic circuit 444 and a second logic circuit 445.

In the embodiment shown in FIG. 4, the first comparison circuit 440 has a first input terminal to receive a first modulation signal COMP_buck, a second input terminal to receive a first ramp signal Ramp_buck representative of the input voltage Vin. The first comparison circuit 440 compares the first modulation signal COMP_buck with the first ramp signal Ramp_buck and provides a first comparison signal at an output terminal. The first modulation signal COMP_buck is a sum signal of a first voltage dividing signal (e.g., Vout*k) representative of the output voltage Vout and the control voltage Vx. The first modulation signal COMP_buck is provided by a first modulation signal generator 47. The first comparison circuit 440 comprises a comparator COM1. A non-inverting input terminal of the comparator COM1 receives the first ramp signal Ramp_buck. An inverting input terminal of the comparator COM1 receives the first modulation signal COMP_buck, and an output terminal of the comparator COM1 provides the first comparison signal.

In the embodiment shown in FIG. 4, the second comparison circuit 441 has a first input terminal to receive a second modulation signal COMP_boost, a second input terminal to receive a second ramp signal Ramp_boost representative of the output voltage Vout. The second comparison circuit 441 compares the second modulation signal COMP_boost with the second ramp signal Ramp_boost and provides a second comparison signal at an output terminal. The second modulation signal COMP_boost is a difference signal provided by subtracting the control voltage Vx from a second voltage dividing signal (e.g., Vin*k) representative of the input voltage Vin. In one embodiment, the first voltage dividing signal Vout*k and the second voltage dividing signal (Vin*k) both have the same proportion factor k. The second modulation signal COMP_boost can be provided by a second modulation signal generator 48. The second comparison circuit 441 comprises a comparator COM2. A non-inverting input terminal of the comparator COM2 receives the second ramp signal Ramp_boost. An inverting input terminal of the comparator COM2 receives the second modulation signal COMP_boost, and an output terminal of the comparator COM2 provides the second comparison signal.

The switching cycle control circuit 443 is configured to provide a switching cycle control signal RST to determine the switching cycle of the first pulse width modulation signal SW_buck or the second pulse width modulation signal SW_boost. In one embodiment, the switching cycle control signal RST has a first type transition edge and a second type transition edge in each switching cycle. In one embodiment, the switching cycle control circuit 443 provides the switching cycle control signal RST with the first type transition edge (e.g., a rising edge) when the first ramp signal Ramp_buck increases to the second voltage dividing signal Vin*k. In another embodiment, the switching cycle control circuit 443 provides the switching cycle control signal RST with the first type transition edge (e.g., a rising edge) when the second ramp signal Ramp_boost increases to the first voltage dividing signal Vout*k.

In the embodiment shown in FIG. 4, the switching cycle control circuit 443 comprises a comparator COM3. A non-inverting input terminal of the comparator COM3 receives the first ramp signal Ramp_buck. An inverting input terminal of the comparator COM3 receives the second voltage dividing signal Vin*k, and an output terminal of the comparator COM3 provides the switching cycle control signal RST. In another embodiment, the switching cycle control circuit 443 comprises a timer circuit, to determine the switching cycle based on the input voltage Vin.

Referring still to FIG. 4, the first logic circuit 444 provides the first pulse width modulation signal SW_buck based upon the first comparison signal, the switching cycle control signal RST and the second pulse width modulation signal SW_boost. When the second pulse width modulation signal SW_boost becomes a constant voltage level (e.g., logic high), the first logic circuit 444 defines a first duty cycle Duty_buck of the first pulse width modulation signal SW_buck based on the first comparison signal and the switching cycle control signal RST, to control the first switch pair 11 to work complementarily. In the embodiment shown in FIG. 4, the first logic circuit 444 comprises a first AND gate circuit AND1 and a first trigger circuit FF1. The first AND gate circuit AND1 has a first input terminal to receive the first comparison signal, a second input terminal to receive the second pulse width modulation signal SW_boost and an output terminal. The first trigger circuit FF1 has a set terminal, a reset terminal, an output terminal and an inverting output terminal, wherein the set terminal is coupled to the output terminal of the first AND gate circuit AND1, the reset terminal is configured to receive the switching cycle control signal RST. The first trigger circuit FF1 is configured to provide the first pulse width modulation signal SW_buck to control the switches Q1 and Q2 to work complementarily. In one embodiment shown in FIG. 4, the first trigger circuit FF1 provides the first pulse width modulation signal SW_buck at the inverting output terminal, and provides an inverting signal of the first pulse width modulation signal SW_buck at the output terminal, for controlling the switches Q1 and Q2 to work complementarily.

As shown in FIG. 4, the second logic circuit 445 provides the second pulse width modulation signal SW_boost based upon the second comparison signal, the switching cycle control signal RST and the first pulse width modulation signal SW_buck. When the first pulse width modulation signal SW_buck becomes the constant voltage level (e.g., logic high), the second logic circuit 445 is configured to define a second duty cycle Duty_boost of the second pulse width modulation signal SW_boost based on the second comparison signal and the switching cycle control signal RST, to control the second switch pair 22 to work complementarily.

In the embodiment shown in FIG. 4, the second logic circuit 445 comprises a second AND gate circuit AND2 and a second trigger circuit FF2. The second AND gate circuit AND2 has a first input terminal to receive the second comparison signal, a second input terminal to receive the first pulse width modulation signal SW_buck and an output terminal. The second trigger circuit FF2 has a set terminal, a reset terminal, an output terminal and an inverting output terminal, wherein the set terminal is coupled to the output terminal of the second AND gate circuit AND2, the reset terminal is configured to receive the switching cycle control signal RST. The second trigger circuit FF2 is configured to provide the second pulse width modulation signal SW_boost at the inverting output terminal, to provide an inverting signal of the second pulse width modulation signal SW_boost at the output terminal, for controlling the fourth switch Q4 and the third switch Q3 to work complementarily.

In one embodiment, the pulse width modulation circuit 44A further comprise a first ramp signal generator 45 for providing the first ramp signal Ramp_buck and a second ramp signal generator 46 for providing the second ramp signal Ramp_boost. The first ramp signal generator 45 comprises a first current source, a first capacitor C1, and a first discharge switch S1. The first current source is coupled to a power supply VS and provides a first charging current Vin*g to charge the first capacitor C1. The first ramp signal Ramp_buck increases from 0. In response to the first type transition edge of the switching cycle control signal RST, the first discharge switch S1 is turned on for discharging the first capacitor C1, to reset the first ramp signal Ramp_buck to 0.

The second ramp signal generator 46 comprises a second current source, a second capacitor C2, and a second discharge switch S2. The second current source is coupled to the power supply VS and provides a second charging current Vout*g to charge the second capacitor C2. The second ramp signal Ramp_boost increases from 0. In response to the first type transition edge of the switching cycle control signal RST, the second discharge switch S2 is turned on for discharging the second capacitor C2, to reset the second ramp signal Ramp_boost to 0.

In the embodiment shown in FIG. 4, the first ramp signal Ramp_buck, the second ramp signal Ramp_boost and the switching cycle control signal RST are in phase.

Those skilled in the art should understand that circuits in the control circuit may not be limited to the specific embodiments shown in FIG. 2~4. For example, the non-inverting terminal and inverting terminal of a comparator can be interchangeable to achieve the same function with the logic level contrary to the illustrated embodiments.

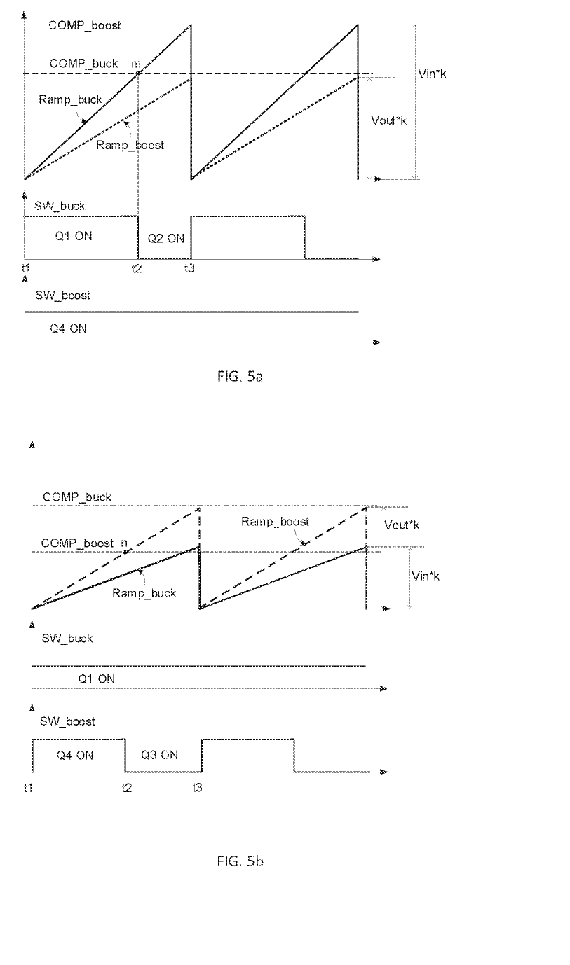

FIG. 5a-5d respectively show working waveforms of the pulse width modulation circuit 44A in accordance with a respective embodiment of the present invention. Several details of the embodiments will be described below with reference to FIGS. 5a-5d.

In the embodiment shown in FIG. 5a, the input voltage Vin is higher than the output voltage Vout. The first modulation signal COMP_buck is less than the second modulation signal COMP_boost. A rising slope of the first ramp signal Ramp_buck is also higher than that of the second ramp signal Ramp_boost. From time t1, the first ramp signal Ramp_buck and the second ramp signal Ramp_boost both increase from zero. The switching cycle control signal RST provided by the switching cycle control circuit 443 shown in FIG. 4 keeps logic low. The first pulse width modulation signal SW_buck and the second pulse width modulation signal SW_boost both keep logic high, thus the first switch Q1 and the fourth switch Q4 are turned on, the second switch Q2 and the third switch Q3 are turned off.

At time t2, the first ramp signal Ramp_buck increases to reach the first modulation signal COMP_buck, as a point m shown in FIG. 5a. The second pulse width modulation signal SW_boost is still logic high, the fourth switch Q4 is kept on and the third switch Q3 is kept off. The first pulse width modulation signal SW_buck becomes logic low, the second switch Q2 is turned on and the first switch Q1 is turned off.

At time t3, the first ramp signal Ramp_buck increases to reach the second voltage dividing signal Vin*k, and the current switching cycle is over. The first ramp signal Ramp_buck and the second ramp signal Ramp_boost are both reset to zero by the switching cycle control signal RST. From time t3, a new switching cycle starts.

In the embodiment shown in FIG. 5b, the input voltage Vin is less than the output voltage Vout. The first modulation signal COMP_buck is higher than the second modulation signal COMP_boost. The rising slope of the first ramp signal Ramp_buck is also less than the one of the second ramp signal Ramp_boost. As shown in FIG. 5b, from time t1, the first ramp signal Ramp_buck and the second ramp signal Ramp_boost both increase from zero. The first pulse width modulation signal SW_buck and the second pulse width modulation signal SW_boost both keep logic high, thus the first switch Q1 and the fourth switch Q4 are turned on, the second switch Q2 and the third switch Q3 are turned off.

At time t2, the second ramp signal Ramp_boost increases to reach the second modulation signal COMP_boost, as a point n shown in FIG. 5b. The first pulse width modulation signal SW_buck is still the logic high, the first switch Q1 is kept on and the second switch Q2 is kept off. The second pulse width modulation signal SW_boost becomes logic low, the third switch Q3 is turned on and the fourth switch Q4 is turned off.

At time t3, the second ramp signal Ramp_boost increases to reach the first voltage dividing signal Vout*k, and the current switching cycle is over. The first ramp signal Ramp_buck and the second ramp signal Ramp_boost are both reset to zero. From time t3, a new switching cycle starts.

In the embodiment shown in FIG. 5c, the input voltage Vin is slightly higher than the output voltage Vout, the input voltage Vin approaches the output voltage Vout. The first modulation signal COMP_buck is slightly less than the second modulation signal COMP_boost. The rising slope of the first ramp signal Ramp_buck is also approaching the one of the second ramp signal Ramp_boost.

The first ramp signal Ramp_buck increases to reach the first modulation signal COMP_buck, as the point m shown in FIG. 5c, which is slightly earlier than the time when the second ramp signal Ramp_boost increases to reach the second modulation signal COMP_boost, as the point n shown in FIG. 5c. Compared with FIG. 5a, the first pulse width modulation signal SW_buck shown in FIG. 5c has a bigger duty cycle Duty_buck.

In the embodiment shown in FIG. 5d, the input voltage Vin is slightly less than the output voltage Vout, the input voltage Vin approaches the output voltage Vout. The first modulation signal COMP_buck is slightly higher than the second modulation signal COMP_boost. The time when the first ramp signal Ramp_buck increases to the first modulation signal COMP_buck (as the point m shown in FIG. 5d), is slightly later than the time when the second ramp signal Ramp_boost increases to the second modulation signal COMP_boost (as the point n shown in FIG. 5d). Compared with FIG. 5b, the second pulse width modulation signal SW_boost shown in FIG. 5d has a bigger duty cycle Duty_boost.

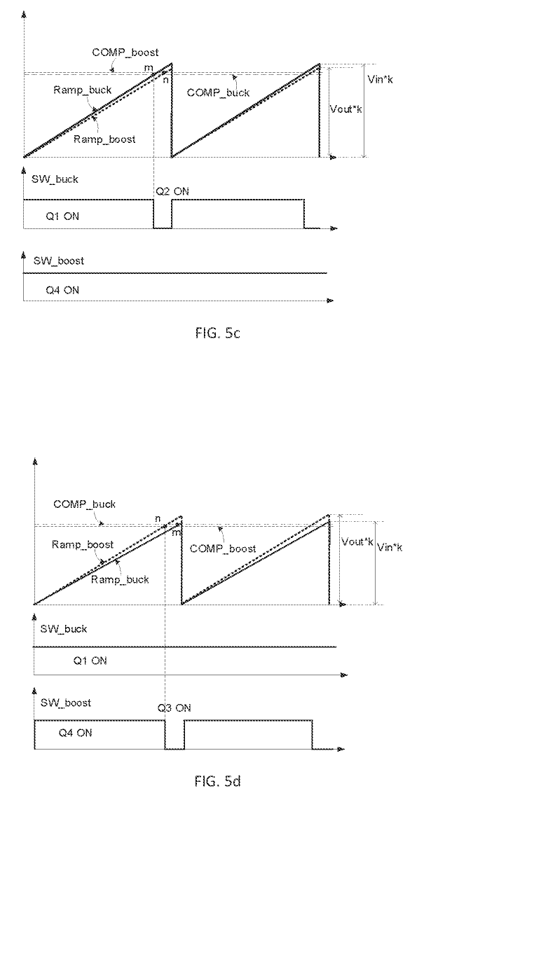

FIG. 6 shows working waveform of the switching converter 10A in accordance with an embodiment of the present invention. As shown in FIG. 6, the input voltage Vin increases from 5V to 20V, then decreases to 5V. The output voltage Vout is kept at 10V after being regulated.

In the embodiment shown in FIG. 6, when the input voltage Vin is less than and does not approach the output voltage Vout, the first pulse width modulation signal SW_buck is kept at logic high. The first switch Q1 is kept on, the first terminal SWA of the inductor L is coupled to the input voltage Vin. A voltage VSWA at the first terminal SWA of the inductor L increases from 5V to follow the input voltage Vin. The second pulse width modulation signal SW_boost controls the second switch pair 22 switching, the third switch Q3 and the fourth switch Q4 work complementarily. The second terminal SWB of the inductor L is selectively coupled to the output voltage Vout or the reference ground. A voltage VSWB at the second terminal SWB of the inductor L changes between the output voltage Vout and zero.

Referring still to FIG. 6, when the input voltage Vin is higher than and does not approach the output voltage Vout, the second pulse width modulation signal SW_boost is kept at logic high. The fourth switch Q4 is kept on, the second terminal SWB of the inductor L is coupled to the output voltage Vout. The first pulse width modulation signal SW_buck controls the first switch pair 11 switching, the first switch Q1 and the second switch Q2 work complementarily. The first terminal SWA of the inductor L is selectively coupled to the input voltage Vin or the reference ground. The voltage VSWA at the first terminal SWA of the inductor L changes between the input voltage Vin and zero.

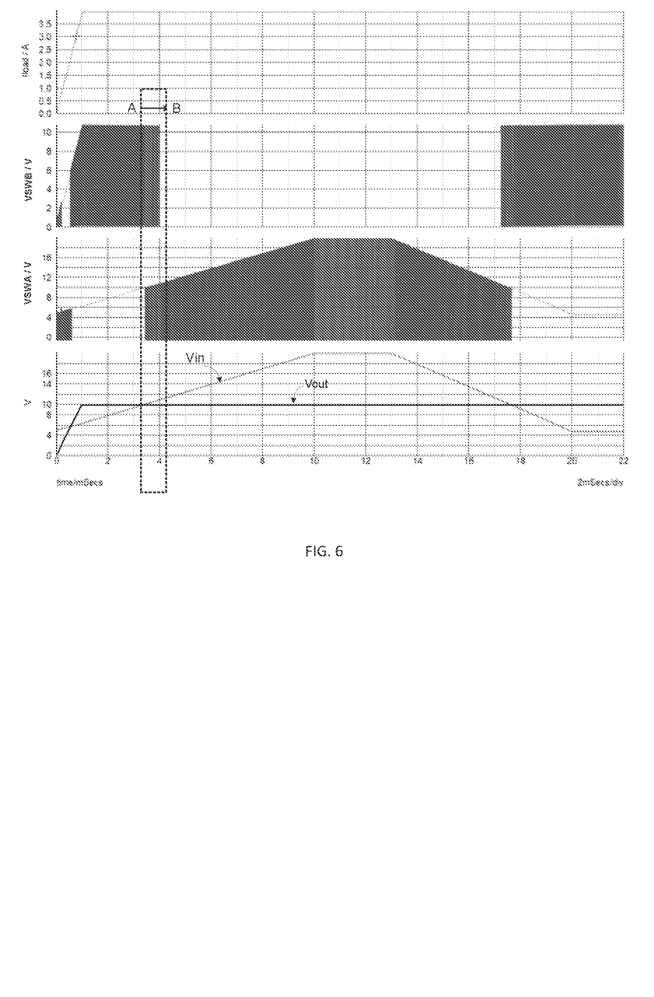

Furthermore, during a time period from A to B shown in FIG. 6, the input voltage Vin approaches the output voltage Vout. FIG. 7 shows a zoom-in view of the working waveforms during the time period from A to B, in accordance with an embodiment of the present invention. When the input voltage Vin approaches the output voltage Vout, the input voltage Vin is slightly higher or slightly less than the output voltage Vout, the control circuit can switch between BUCK mode and BOOST mode.

In one switching cycle as BUCK mode, the second pulse width modulation signal SW_boost is kept at logic high. The voltage VSWB is substantially equal to the output voltage Vout, the first terminal SWA of the inductor L is selectively coupled to the input voltage Vin or the reference ground.

In another switching cycle as BOOST mode, the first pulse width modulation signal SW_buck is kept at logic high. The voltage VSWA is substantially equal to the input voltage Vin, the second terminal SWB of the inductor L is selectively coupled to the output voltage Vout or the reference ground. It should be noted that, in a single switching cycle, the first pulse width modulation signal SW_buck or the second pulse width modulation signal SW_boost is kept at logic high.

In accordance with an exemplary embodiment of the present invention, the first pulse width modulation signal SW_buck and the second pulse width modulation signal SW_boost can achieve seamless, automotive and continuous transition to work either in the BUCK mode or in the BOOST mode, to meet the demand of wide input voltage range. It not only improves the efficiency of the system, but also saves circuit costs and improves system performance.

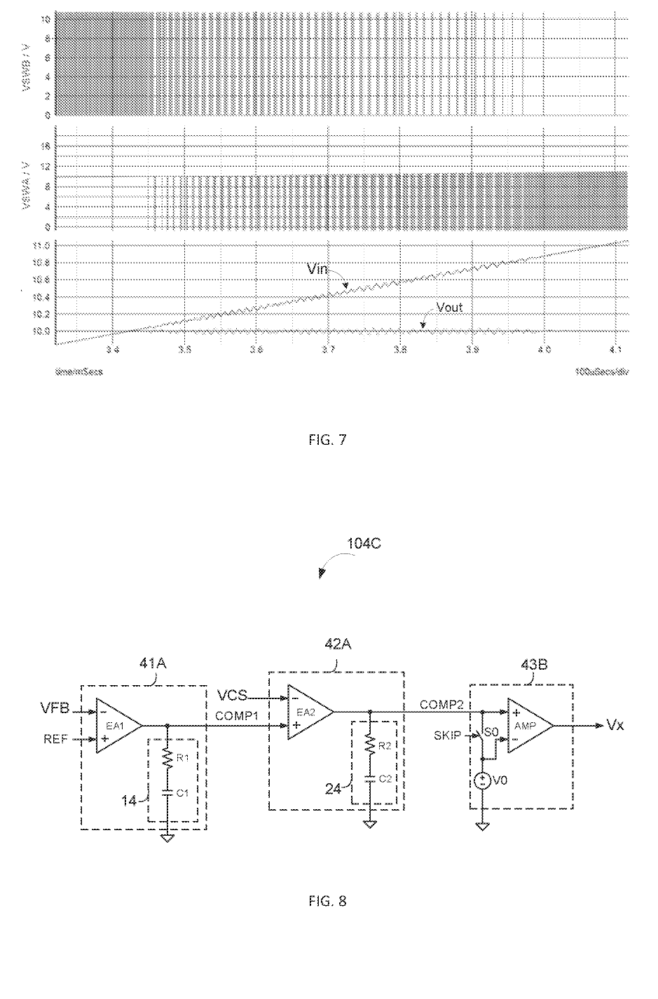

FIG. 8 shows partial circuit diagram of the control circuit 104C in accordance with an embodiment of the present invention. Compared with FIG. 3, the control voltage generator 43B shown in FIG. 8 further comprises a control switch S0. The control switch S0 is coupled between the first input terminal and the second input terminal of the control voltage generator 43B and is controlled by a clamp control signal SKIP. The control switch S0 is turned on when the clamp control signal SKIP indicates that the first error amplifying signal COMP1 is less than a first threshold voltage. At this time, the non-inverting input terminal and the inverting input terminal of the operational amplifier AMP are coupled together and the control voltage Vx becomes 0. The first pulse width modulation signal SW_buck and the second modulation signal SW_boost are paused and the switches Q1-Q4 are all turned off.

The control switch S0 is turned off when the clamp control signal SKIP indicates that the first error amplifying signal COMP1 is higher than the first threshold voltage. Based on the voltage difference between the second error amplifying signal COMP2 and the reference voltage V0, the control voltage generator 43B provides the control voltage Vx to change from 0. In one embodiment, the control voltage Vx is a positive value. In another embodiment, the control voltage Vx is a negative value.

In one embodiment, the control circuit 104C may further comprise a detection circuit to determine if the first error amplifying signal COMP1 is less than the first threshold voltage and to provide the clamp control signal SKIP based thereupon.

In one embodiment, the control voltage Vx becomes zero in response to the first error amplifying signal COMP1 decreasing to be less than the first threshold voltage. In another example, the control voltage Vx starts to change from zero in response to the first error amplifying signal COMP1 increasing to be higher than the first threshold voltage.

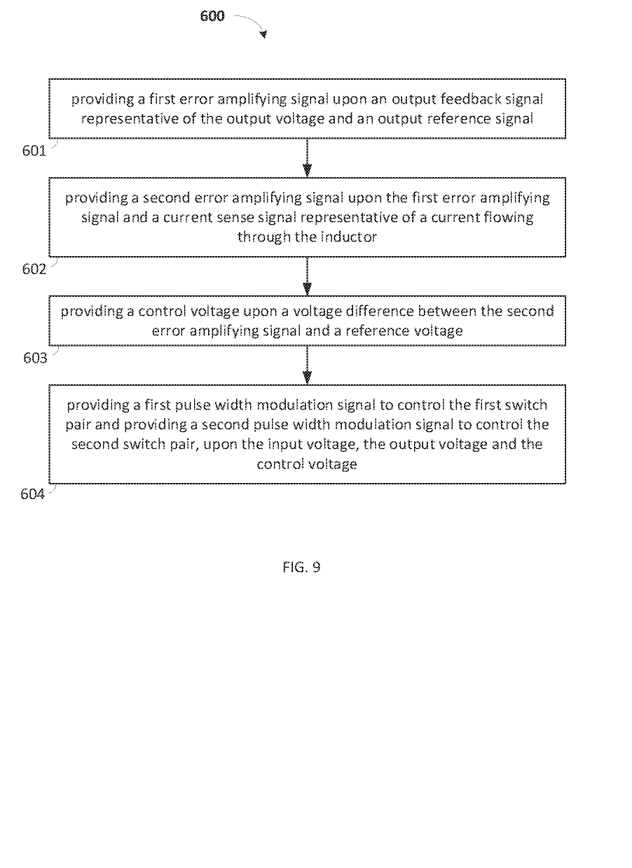

FIG. 9 shows a flow diagram of a method 600 used in a switching converter in accordance with an embodiment of the present invention. The switching converter has an inductor, a first switch pair coupled in series between an input voltage and a reference ground, and a second switch pair coupled in series between an output voltage and the reference ground. The control method 600 comprises steps 601~604.

In step 601, a first error amplifying signal is provided based upon an output feedback signal representative of the output voltage and an output reference signal.

In step 602, a second error amplifying signal is provided based upon the first error amplifying signal and a current sense signal representative of a current flowing through the inductor.

In step 603, a control voltage is generated based upon a voltage difference between the second error amplifying signal and a reference voltage.

In step 604, a first pulse width modulation signal and a second pulse width modulation signal are generated based upon the input voltage, the output voltage and the control voltage. The first pulse width modulation signal is provided to control the first switch pair for selectively coupling a first terminal of the inductor to the input voltage or the reference ground. And the second pulse width modulation signal is provided to control the second switch pair for selectively coupling a second terminal of the inductor to the output voltage or the reference ground.

In one embodiment, the first pulse width modulation signal and the second pulse width modulation signal are paused, the first switch pair and the second switch pair are not switching, in response to the first error amplifying signal decreasing to less than a first threshold voltage. Subsequently, the first pulse width modulation signal and the second pulse width modulation signal are resumed after pause and are transmitted to the first switch pair and the second switch pair for a conversion process, in response to the first error amplifying signal increasing to higher than the first threshold voltage.

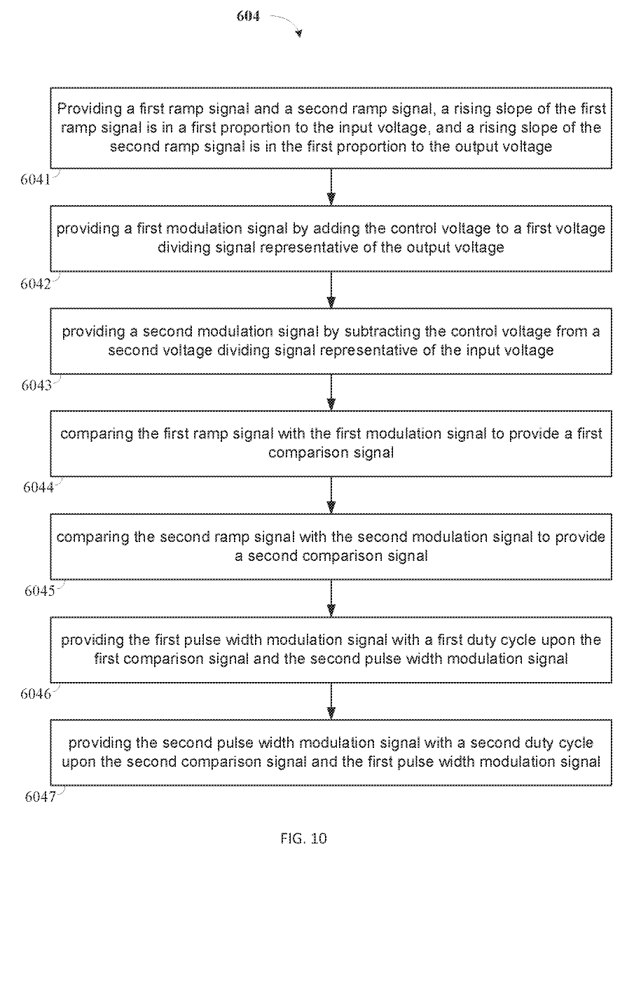

FIG. 10 shows a flow diagram of a step 604 shown in FIG. 9 in accordance with an embodiment of the present invention. As shown in FIG. 10, the step 604 may comprise the steps 6041~6047.

In step 6041, a first ramp signal and a second ramp signal are provided. A rising slope of the first ramp signal is in a first proportion to the input voltage, and a rising slope of the second ramp signal is in the first proportion to the output voltage.

In step 6042, a first modulation signal is generated by adding the control voltage to a first voltage dividing signal representative of the output voltage.

In step 6043, a second modulation signal is generated by subtracting the control voltage from a second voltage dividing signal representative of the input voltage.

In step 6044, the first ramp signal is compared with the first modulation signal to provide a first comparison signal.

In step 6045, the second ramp signal is compared with the second modulation signal to provide a second comparison signal.

In step 6046, the first pulse width modulation signal with a first duty cycle is generated based upon the first comparison signal and the second pulse width modulation signal.

In step 6047, the second pulse width modulation signal with a second duty cycle is generated based upon the second comparison signal and the first pulse width modulation signal.

In one embodiment, during one switching cycle, firstly, the first terminal of the inductor is coupled to the input voltage and the second terminal of the inductor is coupled to the output voltage. Subsequently, if a rising edge of the first comparison signal is earlier than a rising edge of the second comparison signal, the first terminal of the inductor is disconnected from the input voltage, and then connected to the reference ground. Else if the rising edge of the first comparison signal is later than the rising edge of the second comparison signal, the second terminal of the inductor is disconnected from the output voltage, and then connected to the reference ground.

It is to be understood that “substantially” is a term of art, and is meant to convey the principle that relationship such simultaneity or perfect synchronization cannot be met with exactness, but only within the tolerances of the technology available to a practitioner of the art under discussion.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A switching converter comprising:
a first switch pair configured to be coupled in series between an input voltage and a reference ground, for selectively coupling a first terminal of an inductor to the input voltage or the reference ground;
a second switch pair configured to be coupled in series between an output voltage and the reference ground, for selectively coupling a second terminal of the inductor to the output voltage or the reference ground;
a first error amplifying circuit configured to receive an output feedback signal representative of the output voltage and to provide a first error amplifying signal based upon the output feedback signal and an output reference signal;
a second error amplifying circuit configured to receive the first error amplifying signal and a current sense signal representative of a current flowing through the inductor, and to provide a second error amplifying signal based upon the first error amplifying signal and the current sense signal;
a control voltage generator having a first input terminal to receive the second error amplifying signal and a second input terminal to receive a reference voltage, wherein the control voltage generator is configured to provide a control voltage based upon a voltage difference between the second error amplifying signal and the reference voltage; and
a pulse width modulation circuit configured to provide a first pulse width modulation signal for controlling the first switch pair and a second pulse width modulation signal for controlling the second switch pair, based upon the input voltage, the output voltage and the control voltage.

2. The switching converter of claim 1, wherein the pulse width modulation circuit comprises:
a first comparison circuit having a first input terminal to receive a first modulation signal and a second input terminal to receive a first ramp signal representative of the input voltage, wherein the first comparison circuit compares the first modulation signal with the first ramp signal and provides a first comparison signal;
a second comparison circuit having a first input terminal to receive a second modulation signal and a second input terminal to receive a second ramp signal representative of the output voltage, wherein the second comparison circuit compares the second modulation signal with the second ramp signal and provides a second comparison signal;
a switching cycle control circuit configured to provide a switching cycle control signal;
a first logic circuit configured to provide the first pulse width modulation signal based upon the first comparison signal, the switching cycle control signal and the second pulse width modulation signal; and
a second logic circuit configured to provide the second pulse width modulation signal based upon the second comparison signal, the switching cycle control signal and the first pulse width modulation signal.

3. The switching converter of claim 2, wherein:
the first modulation signal is a sum signal of the control voltage and a first voltage dividing signal representative of the output voltage;
the second modulation signal is a difference signal provided by subtracting the control voltage from a second voltage dividing signal representative of the input voltage; and
the switching cycle control signal is provided in response to the first ramp signal increasing to the second voltage dividing signal.

4. The switching converter of claim 2, further comprising:
a first ramp signal generator configured to provide the first ramp signal, comprising:
a first capacitor;
a first current source configured to provide a first charging current for charging the first capacitor, wherein the first charging current is proportional to the input voltage; and
a first discharge switch configured to discharge the first capacitor in response to the switching cycle control signal; and
a second ramp signal generator configured to provide the second ramp signal, comprising:
a second capacitor;
a second current source configured to provide a second charging current for charging a second capacitor, wherein the second charging current is proportional to the output voltage; and
a second discharge switch configured to discharge the second capacitor in response to the switching cycle control signal.

5. The switching converter of claim 2, wherein the first ramp signal, the second ramp signal and the switching cycle control signal are in phase.

6. The switching converter of claim 1, wherein:
the first pulse width modulation signal and the second pulse width modulation signal are paused in response to the first error amplifying signal decreasing to be less than a first threshold voltage; and
the first pulse width modulation signal and the second pulse width modulation signal are transmitted to the first switch pair and the second switch pair for a conversion process in response to the first error amplifying signal increasing to higher than the first threshold voltage.

7. The switching converter of claim 6, further comprising:
a control switch coupled between the first input terminal and the second input terminal of the control voltage generator, wherein the control switch is turned on when the first error amplifying signal is less than the first threshold voltage, and the control switch is turned off when the first error amplifying signal is higher than the first threshold voltage.

8. A control circuit for a switching converter, comprising:
a first error amplifying circuit configured to receive an output feedback signal representative of an output voltage of the switching converter and to provide a first error amplifying signal based upon the output feedback signal and an output reference signal;
a second error amplifying circuit configured to receive the first error amplifying signal and a current sense signal representative of a current flowing through an inductor of the switching converter, and to provide a second error amplifying signal based upon the first error amplifying signal and the current sense signal;
a control voltage generator having a first input terminal configured to receive the second error amplifying signal and a second input terminal configured to receive a reference voltage, wherein the control voltage generator is configured to provide a control voltage based upon a voltage difference between the second error amplifying signal and the reference voltage; and
a pulse width modulation circuit configured to provide a first pulse width modulation signal and a second pulse width modulation signal based upon an input voltage, the output voltage and the control voltage, wherein the first pulse width modulation signal is used to control a first switch pair of the switching converter for selectively coupling a first terminal of the inductor to the input voltage or a reference ground of the switching converter, and the second pulse width modulation signal is used to control a second switch pair of the switching converter for selectively coupling a second terminal of the inductor to the output voltage or the reference ground.

9. The control circuit of claim 8, wherein the pulse width modulation circuit comprising:
a first comparison circuit having a first input terminal to receive a first modulation signal, a second input terminal to receive a first ramp signal representative of the input voltage, the first comparison circuit compares the first modulation signal with the first ramp signal and provides a first comparison signal;
a second comparison circuit having a first input terminal to receive a second modulation signal, a second input terminal to receive a second ramp signal representative of the output voltage, the second comparison circuit compares the second modulation signal with the second ramp signal and provides a second comparison signal;
a switching cycle control circuit configured to provide a switching cycle control signal;
a first logic circuit configured to provide the first pulse width modulation signal based upon the first comparison signal, the switching cycle control signal and the second pulse width modulation signal; and
a second logic circuit configured to provide the second pulse width modulation signal based upon the second comparison signal, the switching cycle control signal and the first pulse width modulation signal.

10. The control circuit of claim 9, wherein:
the first modulation signal is a sum signal of the control voltage and a first voltage dividing signal representative of the output voltage;
the second modulation signal is a difference signal provided by subtracting the control voltage from a second voltage dividing signal representative of the input voltage; and
the switching cycle control signal with a first type transition edge is provided in response to the first ramp signal increasing to the second voltage dividing signal.

11. The control circuit of claim 9, further comprising:
a first ramp signal generator configured to provide the first ramp signal, comprising:
a first current source configured to provide a first charging current being in a first proportion to the input voltage for charging a first capacitor; and
a first discharge switch configured to discharge the first capacitor in response to a first type transition edge of the switching cycle control signal; and
a second ramp signal generator configured to provide the second ramp signal, comprising:
a second current source configured to provide a second charging current being in the first proportion to the output voltage for charging a second capacitor; and
a second discharge switch configured to discharge the second capacitor in response to the first type transition edge of the switching cycle control signal.

12. The control circuit of claim 9, wherein the first ramp signal, the second ramp signal and the switching cycle control signal are in phase.

13. The control circuit of claim 8, wherein:
the control voltage becomes zero in response to the first error amplifying signal decreasing to less than a first threshold voltage; and
the control voltage starts to change from zero in response to the first error amplifying signal increasing to higher than the first threshold voltage.

14. The control circuit of claim 13, further comprising:
a control switch coupled between the first input terminal and the second input terminal of the control voltage generator and configured to being controlled by a clamp control signal, wherein the control switch is turned on when the clamp control signal indicates that the first error amplifying signal is less than the first threshold voltage, and the control switch is turned off when the clamp control signal indicates that the first error amplifying signal is higher than the first threshold voltage.

15. A control circuit for a switching converter, wherein:
the control circuit switches between a first mode and a second mode when an input voltage approaches an output voltage, wherein in the first mode, during one switching cycle, a first terminal of an inductor of the switching converter is selectively coupled to the input voltage or a reference ground and a voltage at a second terminal of the inductor is substantially equal to the output voltage, and in the second mode, during one switching cycle, a voltage at the first terminal of the inductor is substantially equal to the input voltage and the second terminal of the inductor is selectively coupled to the output voltage or the reference ground.

16. The control circuit of claim 15, further comprising:
a first error amplifying circuit configured to receive an output feedback signal representative of the output voltage and to provide a first error amplifying signal based upon the output feedback signal and an output reference signal;
a second error amplifying circuit configured to receive the first error amplifying signal and a current sense signal representative of a current flowing through the inductor, and to provide a second error amplifying signal based upon the first error amplifying signal and the current sense signal;
a control voltage generator having a first input terminal configured to receive the second error amplifying signal and a second input terminal configured to receive a reference voltage, wherein the control voltage generator is configured to provide a control voltage based upon a voltage difference between the second error amplifying signal and the reference voltage; and
a pulse width modulation circuit configured to provide a first pulse width modulation signal and a second pulse width modulation signal based upon the input voltage, the output voltage and the control voltage, wherein the first pulse width modulation signal is used to control a first switch pair of the switching converter, and the second pulse width modulation signal is used to control a second switch pair of the switching converter.

17. The control circuit of claim 16, wherein the pulse width modulation circuit comprises:
a first comparison circuit having a first input terminal to receive a first modulation signal and a second input terminal to receive a first ramp signal representative of the input voltage, wherein the first comparison circuit compares the first modulation signal with the first ramp signal and provides a first comparison signal;
a second comparison circuit having a first input terminal to receive a second modulation signal and a second input terminal to receive a second ramp signal representative of the output voltage, wherein the second comparison circuit compares the second modulation signal with the second ramp signal and provides a second comparison signal;
a switching cycle control circuit configured to provide a switching cycle control signal;
a first logic circuit configured to provide the first pulse width modulation signal based upon the first comparison signal, the switching cycle control signal and the second pulse width modulation signal; and
a second logic circuit configured to provide the second pulse width modulation signal based upon the second comparison signal, the switching cycle control signal and the first pulse width modulation signal.

18. The control circuit of claim 17, wherein:
the first modulation signal is a sum signal of the control voltage and a first voltage dividing signal representative of the output voltage;
the second modulation signal is a difference signal provided by subtracting the control voltage from a second voltage dividing signal representative of the input voltage; and
the switching cycle control signal with a first type transition edge is provided in response to the first ramp signal increasing to the second voltage dividing signal.

19. The control circuit of claim 17, wherein the first ramp signal, the second ramp signal and the switching cycle control signal are in phase.

20. The control circuit of claim 16, wherein:
the control voltage becomes zero in response to the first error amplifying signal decreasing to less than a first threshold voltage; and
the control voltage starts to change from zero in response to the first error amplifying signal increasing to higher than the first threshold voltage.
